(19) United States
(12) Patent Application Publication
(10) Pub. No.: US 2025/0376829 A1
(43) Pub. Date: Dec. 11, 2025

(54) REMOTE OPERATION SYSTEM FOR WORK MACHINE

(71) Applicant: SUMITOMO HEAVY INDUSTRIES, LTD., Tokyo (JP)

(72) Inventor: Yusuke SANO, Kanagawa (JP)

(21) Appl. No.: 19/226,623

(22) Filed: Jun. 3, 2025

(30) Foreign Application Priority Data
Jun. 6, 2024 (JP) 2024-091880

(51) Int. Cl. E02F 9/20; E02F 3/32; E02F 9/24; H04N 7/18

(52) U.S. Cl. CPC E02F 9/2033; E02F 9/205; E02F 9/24; E02F 3/32; H04N 7/183

(57) ABSTRACT

A remote operation system for a work machine, the remote operation system including the work machine including a lower traveling body; an upper turning body provided on the lower traveling body so as to be able to turn; an imaging device provided on the upper turning body; and a communication device configured to transmit an image captured by the imaging device; a remote communication device configured to communicate with the communication device; a display device configured to display the image received by the remote communication device; and a remote operation device configured to operate the work machine by performing a remote operation, wherein the remote operation system limits the remote operation when a limitation condition is satisfied, the limitation condition being that an image suitable for the remote operation of the work machine is not displayed on the display device.

### CROSS-REFERENCE TO RELATED APPLICATION

The present application is based on and claims priority under 35 U.S.C. § 119 to Japanese Patent Application No. 2024-091880, filed on Jun. 6, 2024, the contents of which are incorporated herein by reference in their entirety.

### BACKGROUND

### Technical Field

The present disclosure relates to a remote operation system for a work machine.

### Description of Related Art

A remote operation device for a construction machine has been known. The remote operation device for a construction machine described in the related art includes an imaging part for capturing an area similar to the area visible from the cockpit of the construction machine, and a display part for projecting the scenery captured by the imaging part.

### SUMMARY

According to an embodiment of the present invention, there is provided a remote operation system for a work machine, the remote operation system including the work machine including a lower traveling body; an upper turning body provided on the lower traveling body so as to be able to turn; an imaging device provided on the upper turning body; and a communication device configured to transmit an image captured by the imaging device; a remote communication device configured to communicate with the communication device; a display device configured to display the image received by the remote communication device; and a remote operation device configured to operate the work machine by performing a remote operation, wherein the remote operation system limits the remote operation when a limitation condition is satisfied, the limitation condition being that an image suitable for the remote operation of the work machine is not displayed on the display device.

### BRIEF DESCRIPTION OF THE DRAWINGS

FIG. 1 is a schematic view illustrating an embodiment of a remote operation system for a work machine according to the present disclosure;

FIG. 2 is a side view of a work machine included in the remote operation system illustrated in FIG. 1;

FIG. 3 is a block diagram illustrating an example configuration of a drive control system for the work machine illustrated in FIG. 2;

FIG. 4 is a block diagram illustrating an example configuration of the remote operation system illustrated in FIG. 1;

FIG. 5 is a perspective view illustrating an example configuration of a display device of the remote operation system illustrated in FIG. 1;

FIG. 6 is a flow diagram illustrating a processing flow of the remote operation system illustrated in FIG. 1; and

FIG. 7 is a flow diagram illustrating a modified example of the processing flow of the remote operation system illustrated in FIG. 6.

### DETAILED DESCRIPTION

In the remote operation device for a construction machine described in the related art, there is a possibility that a construction machine is remotely operated while an image suitable for remote operation of the construction machine is not displayed on a display part.

The present disclosure provides a remote operation system for a work machine which enables remote operation of the work machine while an image suitable for remote operation of the work machine is displayed on a display part.

According to the above aspect of the present disclosure, it is possible to provide a remote operation system for a work machine that enables remote operation of the work machine while an image suitable for remote operation of the work machine is displayed on a display device.

Embodiments of a remote operation system for a work machine according to the present disclosure will now be described with reference to the drawings. The following embodiments are exemplary rather than limiting the remote operation system of the present disclosure, and all features and combinations thereof relating to the embodiments are not necessarily essential to the remote operation system of the present disclosure. In each of the drawings, the same or corresponding configurations may be denoted by the same or corresponding reference numerals and descriptions thereof may be omitted.

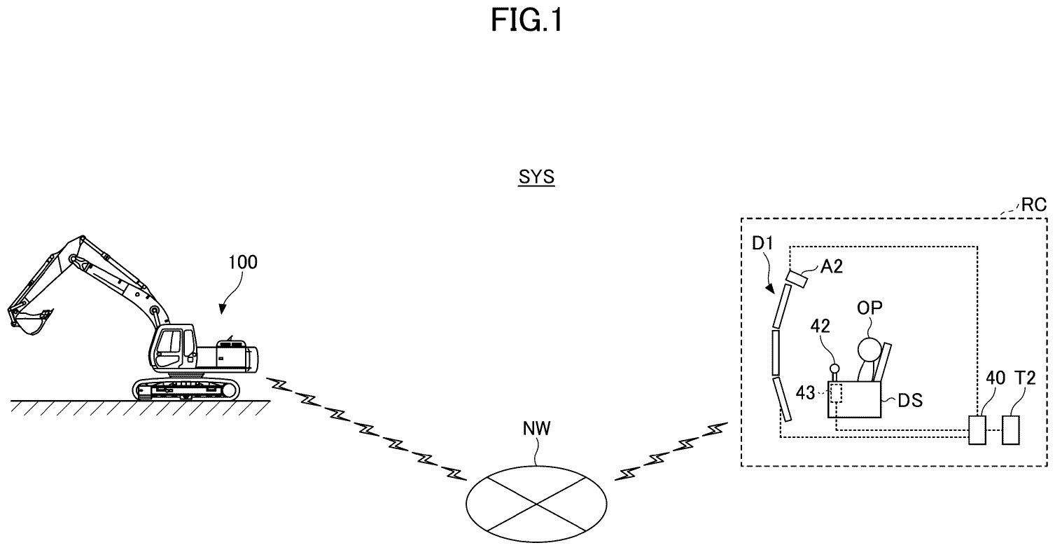

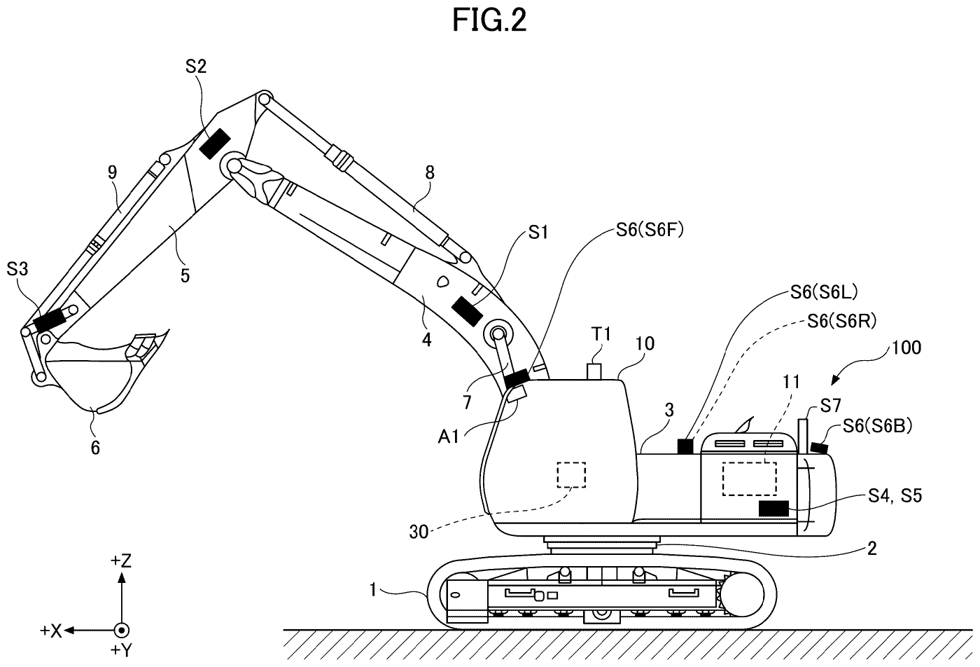

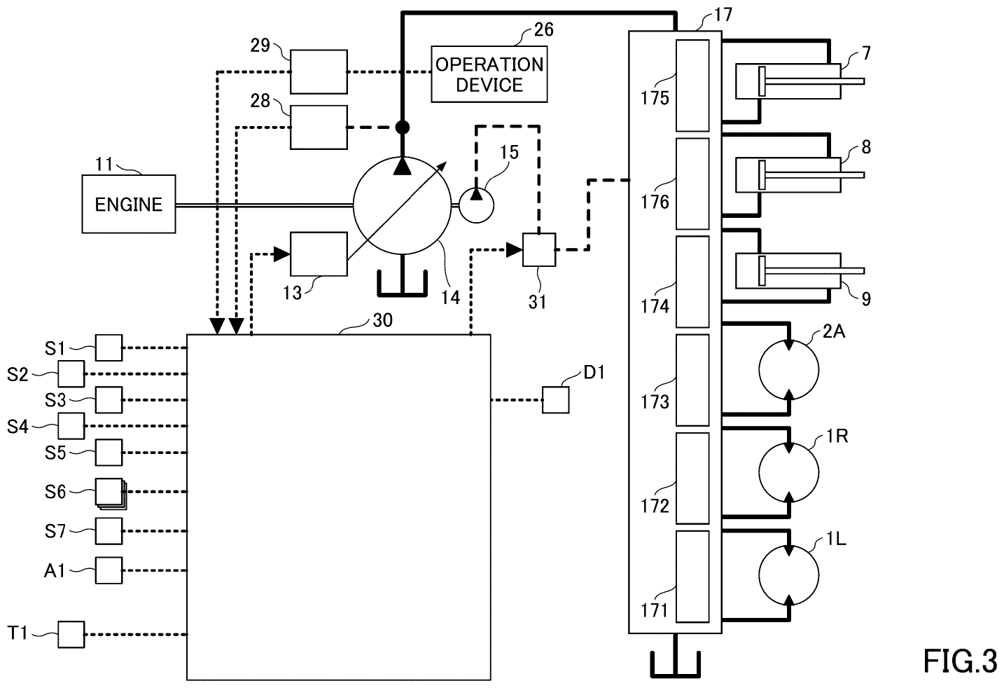

FIG. 1 is a schematic view illustrating an embodiment of a remote operation system for a work machine according to the present disclosure. FIG. 2 is a side view of a work machine 100 included in a remote operation system SYS illustrated in FIG. 1. FIG. 3 is a block diagram illustrating a configuration example of a drive control system of the work machine 100 illustrated in FIG. 2.

As illustrated in FIG. 1, the remote operation system SYS of the work machine of the present embodiment includes one or more work machines 100, a remote communication device T2, a display device D1, and a remote operation device 42. The remote communication device T2, the display device D1, and the remote operation device 42 are installed, for example, in a remote operation room RC separated from the work machine 100. In the remote operation room RC, for example, an operation seat DS, a speaker A2, and the like are installed.

Although details are described below, in the remote operation system SYS of the work machine of the present embodiment, the remote operation of the work machine 100 is limited when the limitation condition is satisfied such that an image suitable for the remote operation of the work machine 100 is not displayed on the display device D1.

As illustrated in FIG. 2, the work machine 100 is provided with a lower traveling body 1, an upper turning body 3 provided on the lower traveling body 1 so as to be able to turn, an imaging device S6 provided on the upper turning body 3, and a communication device Tl for transmitting an image captured by the imaging device S6. In the example illustrated in FIG. 2, the work machine 100 is a hydraulic excavator, but the work machine included in the remote operation system of the work machine according to the present disclosure is not limited to a hydraulic excavator, and may be other work machines such as a crawler type crane or a dump truck, for example.

As illustrated in FIGS. 2 and 3, for example, the lower traveling body 1 of the work machine 100 has left and right crawler tracks driven by left-side and right-side traveling hydraulic motors 1L and 1R, and the work machine 100 is moved by rotating the left and right crawler tracks. As illustrated in FIGS. 2 and 3, for example, the upper turning body 3 of the work machine 100 is mounted on the lower traveling body 1 via the turning mechanism 2 driven by the turning hydraulic motor 2A, so that the upper turning body 3 can turn on the lower traveling body 1.

The three-dimensional rectangular coordinate system illustrated in FIG. 2 has an X axis parallel to the longitudinal direction of the upper turning body 3, a Y axis parallel to the lateral direction of the upper turning body 3, and a Z axis parallel to the vertical direction of the upper turning body 3. Further, in the three-dimensional rectangular coordinate system illustrated in FIG. 2, the positive direction of the X axis (+X direction), the positive direction of the Y axis (+Y direction), and the positive direction of the Z axis (+Z direction) point forward, left, and upward of the upper turning body 3, respectively.

The imaging device S6 of the work machine 100 is provided on the upper turning body 3, for example, to capture an image of the area around the upper turning body 3. As illustrated in FIG. 2, for example, the imaging device S6 includes a front camera S6F for capturing an image of an area in front of the upper turning body 3, a left camera S6L for capturing an image of an area to the left of the upper turning body 3, a right camera S6R for capturing an image of an area to the right of the upper turning body 3, and a rear camera S6B for capturing an image of an area behind the upper turning body 3. The front camera S6F, the left camera S6L, the right camera S6R, and the rear camera S6B are monocular wide-angle cameras equipped with an imaging device such as a CCD or CMOS, for example, and output the captured image to the machine controller 30.

The communication device T1 of the work machine 100 communicates with the remote communication device T2 installed in the remote operation room RC via a communication network NW including a mobile communication network, a satellite communication network, or an Internet network, for example, as illustrated in FIG. 1. The communication device T1 is, for example, a mobile communication module supporting a mobile communication standard such as LTE (Long Term Evolution), 4G (4th Generation), or 5G (5th Generation), a communication module supporting a short-range wireless communication standard such as Wi-Fi (registered trademark) or Bluetooth (registered trademark), or a satellite communication module for connecting to a satellite communication network.

The remote communication device T2 installed in the remote operation room RC communicates with the communication device T1 installed in the work machine 100 via the communication network NW, for example.

The display device D1 installed in the remote operation room RC can display various kinds of information. The display device D1 displays an image based on information transmitted from the work machine 100 in order for the remote operator OP in the remote operation room RC to visually recognize the surroundings of the work machine 100. The display device D1 includes a liquid crystal display or the like for displaying an image captured by the imaging device S6 installed in the work machine 100, and is configured to display an image received by the remote communication device T2. The display device D1 may be a display or a projector for implementing naked eye stereoscopic vision, or VR goggles or the like.

The remote operation device 42 installed in the remote operation room RC has, for example, an operation lever, an operation pedal, an operation panel, an operation button, an operation switch, an operation dial, and the like (not illustrated), similar to the operation device 26 (see FIG. 3) in the driving room 10 of the work machine 100. The remote operation device 42 includes, for example, an operation sensor 43 for detecting the operation of the remote operation device 42 by the remote operator OP.

The operation seat DS installed in the remote operation room RC has, for example, the same configuration as the operation seat in the driving room 10 of the work machine 100 (not illustrated). The remote operator OP who remotely operates the work machine 100, for example, operates the remote operation device 42 by sitting on the operation seat DS. The work machine 100 may be, for example, a work machine 100 exclusively used for remote operation, that does not include the driving room 10, a driving seat, or the operation device 26.

The speaker A2 installed in the remote operation room RC is configured to reproduce, for example, sound based on a signal received by the remote communication device T2. The speaker A2 may be a mono speaker, a stereo speaker, or a surround speaker. The speaker may be a non-directional speaker or a directional speaker. The remote operation system SYS may include a wearable device such as an earphone or a headphone in place of the speaker A2. The wearable device may have a noise canceling function, a spatial audio function (stereo sound function), or a bone conduction function.

The remote operation system SYS further includes, for example, a machine controller 30 illustrated in FIG. 2 and a remote controller 40 illustrated in FIG. 1 in addition to the above-described configuration. The machine controller 30 is provided, for example, in the upper turning body 3 of the work machine 100. The remote controller 40 is provided, for example, in the remote operation room RC separated from the work machine 100.

The machine controller 30 provided in the work machine 100 is an example of a control device and includes, for example, a computer including a CPU, a volatile storage device, a nonvolatile storage device, and various input/output interfaces. The machine controller 30 implements various functions by, for example, reading a program from the nonvolatile storage device, loading it into the volatile storage device, and executing it by the CPU.

The machine controller 30 is configured to implement various functions and control the work machine 100. The various functions include, for example, a machine guidance function for guiding the manual operation of the work machine 100 by the remote operator OP. The various functions may include a contact avoidance function for automatically or autonomously operating or stopping the work machine 100 in order to avoid contact between the work machine 100 and an object existing within the monitoring range around the work machine 100.

The machine controller 30 acquires various kinds of information and signals transmitted from the remote communication device T2 of the remote operation room RC via the communication device T1, and transmits various kinds of information, signals, images, sounds, etc., to the remote communication device T2 of the remote operation room RC via the communication device T1.

The remote controller 40 installed in the remote operation room RC has, for example, the same configuration as the machine controller 30. The remote controller 40 acquires various kinds of information and signals transmitted from the communication device T1 of the work machine 100 via the remote communication device T2, and transmits various kinds of information and signals to the communication device T1 of the work machine 100 via the remote communication device T2. The remote controller 40 causes the display device D1 to display images received via the remote communication device T2, and causes the speaker A2 to replay sounds received via the remote communication device T2.

The remote controller 40 acquires, for example, information related to the operation of the remote operation device 42 by the remote operator OP from the operation sensor 43. The operation sensor 43 is, for example, a tilt sensor for detecting the tilt angle of the operation lever of the remote operation device 42 or an angle sensor for detecting the oscillation angle of the operation lever around the oscillation shaft. The operation sensor 43 may be composed of other sensors such as a pressure sensor, a current sensor, a voltage sensor, or a distance sensor. The operation sensor 43 outputs information about the detected operation contents of the remote operation device 42 to the remote controller 40. The remote controller 40 generates an operation signal based on the received information and transmits the generated operation signal to the work machine 100. The operation sensor 43 may be configured to generate an operation signal. In this case, the operation sensor 43 may output the operation signal to the remote communication device T2 without passing through the remote controller 40. Thus, the remote operation of the work machine 100 can be implemented from the remote operation room RC. The operation signal based on the operation of the remote operation device 42 may be transmitted to the work machine 100 via a communication device other than the remote communication device T2 which receives the image transmitted from the communication device T1 of the work machine 100.

The work machine 100 has, for example, an attachment for performing work on the work site. As illustrated in FIG. 2, the attachment includes, for example, a boom 4 rotatably attached to the right side of the front end of the upper turning body 3, an arm 5 rotatably attached to the tip of the boom 4, and an excavation bucket 6 rotatably attached to the tip of the arm 5.

The bucket 6 is an end attachment attached to the end of the attachment of the work machine 100. The end attachment may be other types of buckets such as large buckets, buckets for slopes, buckets for dredging, etc., or may be work tools other than buckets, such as agitators, breakers, grapples, or lifting magnets.

The boom 4, the arm 5, and the bucket 6 are hydraulically driven by a boom cylinder 7, an arm cylinder 8, and a bucket cylinder 9 which are hydraulic cylinders, respectively. A boom angle sensor S1, an arm angle sensor S2, and a bucket angle sensor S3 are attached to the boom 4, the arm 5, and the bucket 6, respectively. These angle sensors also function as posture sensors for detecting the posture of the attachment.

The boom angle sensor S1, the arm angle sensor S2, and the bucket angle sensor S3 respectively detect the boom angle, the arm angle, and the bucket angle and output them to the machine controller 30. The boom angle, the arm angle, and the bucket angle are the rotation angle of the boom 4 relative to the upper turning body 3, the rotation angle of the arm 5 relative to the boom 4, and the rotation angle of the bucket 6 relative to the arm 5, respectively.

The boom angle is, for example, minimum when the boom 4 is positioned at the lowermost position and maximum when the boom 4 is positioned at the uppermost position. The arm angle is, for example, minimum when the arm 5 is fully closed relative to the boom 4, and maximum when the arm 5 is fully opened relative to the boom 4. The bucket angle is minimum when the bucket 6 is fully closed relative to the arm 5, and maximum when the bucket 6 is fully opened relative to the arm 5.

The boom angle sensor S1, the arm angle sensor S2, and the bucket angle sensor S3 are composed of, for example, respective acceleration sensors. These angle sensors may be, for example, a potentiometer using a variable resistor, a stroke sensor for detecting the stroke amount of a corresponding hydraulic cylinder, or a rotary encoder for detecting the rotation angle around a connecting pin for rotatably connecting each part of the attachment.

The work machine 100 includes, for example, a machine body tilt sensor S4, a turning sensor S5, a positioning device S7, and a microphone A1, as illustrated in FIGS. 2 and 3.

The machine body tilt sensor S4 detects a tilted state of the machine body (the lower traveling body 1 or the upper turning body 3) with respect to a horizontal plane. The machine body tilt sensor S4 is attached to the upper turning body 3, for example, and detects a tilt angle of the work machine 100 (that is, the upper turning body 3) around two axes in the longitudinal direction and the lateral direction. The machine body tilt sensor S4 may be, for example, an acceleration sensor, a 6-axis sensor, or an IMU. The detection signal corresponding to the tilt angle detected by the machine body tilt sensor S4 is taken into the machine controller 30.

The turning sensor S5 outputs information related to the turning of the upper turning body 3. The turning sensor S5 detects, for example, the turning angular velocity of the upper turning body 3 relative to the lower traveling body 1. The turning sensor S5 may detect the turning angle. The turning sensor S5 may be, for example, a gyro sensor, a resolver, or a rotary encoder. The detection signal corresponding to the turning angle or turning angular velocity of the upper turning body 3 detected by the turning sensor S5 is taken into the machine controller 30.

The positioning device S7 measures the position of the upper turning body 3. The positioning device S7 is, for example, a GNSS (Global Navigation Satellite System) compass, and detects the position and orientation of the upper turning body 3. The detection signal corresponding to the position and orientation of the upper turning body 3 is taken into the machine controller 30. The function of detecting the orientation of the upper turning body 3 may be implemented by an azimuth sensor attached to the upper turning body 3.

As illustrated in FIG. 2, for example, the microphone A1 is a sound collecting device which is provided on the upper front side of the driving room 10 of the work machine 100, and collects sound generated around the work machine 100 and converts the sound into an electric signal. The sound signal collected by the microphone A1 is taken into the machine controller 30. The microphone A1 may be, for example, a microphone array composed of a plurality of microphones.

The drive system of the work machine 100 includes, for example, an engine 11, a regulator 13, a main pump 14, and a control valve unit 17, as illustrated in FIGS. 2 and 3. The hydraulic drive system of the work machine 100 includes, for example, hydraulic actuators such as a traveling hydraulic motor 1L, 1R, a turning hydraulic motor 2A, a boom cylinder 7, an arm cylinder 8, and a bucket cylinder 9. In FIG. 3, the mechanical power transmission system, a hydraulic oil line, a pilot line, and an electric control system are indicated by double lines, bold solid lines, bold dashed lines, and dotted lines, respectively.

The engine 11 is an example of a power source of the work machine 100, and is mounted, for example, at the rear of the upper turning body 3. The power source of the work machine 100 may be a combination of a power source such as a battery or a fuel cell and an electric motor. Specifically, the engine 11 rotates at a predetermined target speed under direct or indirect control by the machine controller 30, and drives the main pump 14 and the pilot pump 15. The engine 11 is, for example, a diesel engine using light oil as fuel. The engine 11 may be a gasoline engine or a hydrogen engine.

The regulator 13 controls the discharge amount of the main pump 14. For example, the regulator 13 controls the discharge amount of the main pump 14 by adjusting the angle (tilt angle) of the swash plate of the main pump 14 in response to a control instruction from the machine controller 30.

Similar to the engine 11, for example, the main pump 14 is mounted at the rear of the upper turning body 3 and supplies hydraulic oil to the control valve unit 17 through a hydraulic oil line. In the illustrated example, the main pump 14 is a variable displacement hydraulic pump.

The control valve unit 17 is one example of a hydraulic control device for controlling the hydraulic system in the work machine 100. In the illustrated example, the control valve unit 17 includes control valves 171 to 176. The control valve unit 17 is configured to selectively supply hydraulic oil discharged from the main pump 14 to one or more hydraulic actuators, through the control valves 171 to 176. The control valves 171 to 176 control the flow rate of hydraulic oil flowing from the main pump 14 to the hydraulic actuator and the flow rate of hydraulic oil flowing from the hydraulic actuator to the hydraulic oil tank. The hydraulic actuator includes a boom cylinder 7, an arm cylinder 8, a bucket cylinder 9, traveling hydraulic motors 1R and 1L, and a turning hydraulic motor 2A. Specifically, the control valve 171 corresponds to the left-side traveling hydraulic motor 1L, the control valve 172 corresponds to the right-side traveling hydraulic motor 1R, and the control valve 173 corresponds to the turning hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generation device, and is configured to supply hydraulic oil to the hydraulic control device via a pilot line. In the illustrated example, the pilot pump 15 is a fixed-capacity hydraulic pump. However, the pilot pressure generation device may be implemented by the main pump 14. That is, the main pump 14 may have a function of supplying hydraulic oil to the control valve unit 17 via a hydraulic oil line, and a function of supplying hydraulic oil to various hydraulic control devices via a pilot line. In this case, the pilot pump 15 may be omitted.

The discharge pressure sensor 28 is configured to detect the discharge pressure of the main pump 14. In the illustrated example, the discharge pressure sensor 28 outputs the detected value to the machine controller 30.

The operation device 26 is a device used by an operator to operate an actuator. The operation device 26 includes, for example, an operation lever and an operation pedal. The actuator may be a hydraulic actuator or an electric actuator.

An operation sensor 29 is configured to detect the operation contents of the operator using the operation device 26. In the present embodiment, the operation sensor 29 detects the operation direction and the operation amount of the operation device 26 corresponding to each of the actuators, and outputs the detected values to the machine controller 30. In the illustrated example, the machine controller 30 can control the opening area of the valve 31 according to the output of the operation sensor 29. Then, the machine controller 30 supplies the hydraulic oil discharged from the pilot pump 15 to the pilot port of the corresponding control valve in the control valve unit 17. The pressure (pilot pressure) of the hydraulic oil supplied to each of the pilot ports is, in principle, the pressure corresponding to the operation direction and the operation amount of the operation device 26 corresponding to each of the hydraulic actuators. Thus, the operation device 26 is configured to supply the hydraulic oil discharged from the pilot pump 15 to the pilot port of the corresponding control valve in the control valve unit 17.

The valve 31 functioning as the control valve for machine control is arranged in a pipe line connecting the pilot pump 15 and the pilot port of the control valve in the control valve unit 17, and is configured to change the flow path area of the pipe line. In the illustrated example, the valve 31 is a solenoid valve that operates in response to a control instruction output from the machine controller 30. Therefore, the machine controller 30 can adjust the pilot pressure acting on the pilot port of the control valve by the valve 31, regardless of the operation of the operation device 26 by the operator.

With this configuration, the machine controller 30 can operate the hydraulic actuator corresponding to a specific operation device 26 even when the operation of the specific operation device 26 is not performed. In the work machine 100, all or some of the driven parts such as the lower traveling body 1, the upper turning body 3, the boom 4, the arm 5, and the bucket 6 may be electrically driven. That is, the work machine 100 may be a hybrid shovel or an electric shovel in which all or part of the driven parts are driven by electric actuators.

The driving room 10 is a compartment space in which an operator rides and is provided on the front left side of the upper turning body 3. However, when the work machine 100 is remotely operated or when the work machine 100 is operated by fully automatic operation or remote operation, the driving room 10 may be omitted. The work machine 100 drives the driven parts such as the lower traveling body 1, the upper turning body 3, the boom 4, the arm 5, and the bucket 6 by operating the actuators according to the operation of the operator who rides in the driving room 10. The work machine 100 is configured to be remotely operated from the outside of the work machine 100. When the work machine 100 is remotely operated, the inside of the driving room 10 may be in an unmanned state.

The work machine 100 may automatically operate the actuators regardless of the operation of the operator or the remote operator OP. Thus, the work machine 100 implements a function of automatically operating at least a part of the driven parts such as the lower traveling body 1, the upper turning body 3, the boom 4, the arm 5, and the bucket 6, that is, what is referred to as a “machine control function”.

The machine controller 30 is configured to output a control instruction to the regulator 13 as needed to change the discharge amount of the main pump 14. Further, the machine controller 30 may be configured to control the machine guidance function for guiding the manual operation of the work machine 100 by an operator through the operation device 26, for example. The machine controller 30 may be configured to control the machine control function for automatically supporting the manual operation of the work machine 100 by an operator through the operation device 26, for example.

Note that a part of the functions of the machine controller 30 may be implemented by other controllers (control devices) including the remote controller 40. That is, the functions of the machine controller 30 may be implemented in a manner that is distributed among a plurality of controllers. For example, the machine guidance function and the machine control function may be implemented by an exclusive-use controller (control device).

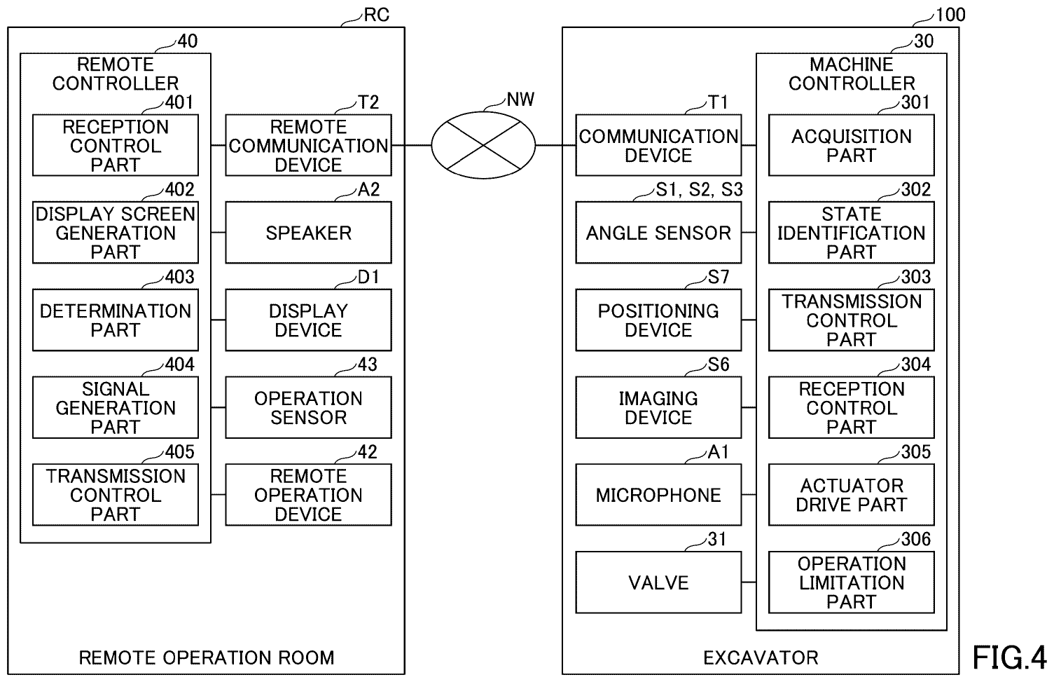

The configuration of the machine controller 30 and the remote controller 40 included in the remote operation system SYS will be described below with reference to FIG. 4. FIG. 4 is a block diagram illustrating an example of the configuration of the remote operation system SYS illustrated in FIG. 1.

The machine controller 30 mounted on the work machine 100 is connected, for example, to the communication device T1, the boom angle sensor S1, the arm angle sensor S2, the bucket angle sensor S3, the imaging device S6, the positioning device S7, the microphone A1, and the valve 31, as described above. The machine controller 30 includes, for example, an acquisition part 301, a state identification part 302, a transmission control part 303, a reception control part 304, an actuator drive part 305, and an operation limitation part 306.

The remote controller 40 installed in the remote operation room RC is connected, for example, to the remote communication device T2, the speaker A2, the display device D1, the remote operation device 42, and the operation sensor 43, as described above. The remote controller 40 includes, for example, a reception control part 401, a display screen generation part 402, a determination part 403, a signal generation part 404, and a transmission control part 405.

Each part of the machine controller 30 and the remote controller 40 illustrated in FIG. 4 represents, for example, each function implemented in each controller by the CPU reading a program from the nonvolatile storage device, loading it into the volatile storage device, and executing it. The functions of the machine controller 30 and the remote controller 40 will be described below.

The acquisition part 301 of the machine controller 30 acquires, for example, signals input to the machine controller 30 from various devices provided in the work machine 100. Specifically, the acquisition part 301 acquires, for example, detection results of the boom angle sensor S1, the arm angle sensor S2, the bucket angle sensor S3, the machine body tilt sensor S4, the turning sensor S5, the positioning device S7, and the like. The acquisition part 301 acquires, for example, image information related to an image of the surroundings of the work machine 100 captured by the imaging device S6, and sound signals generated from sounds of the surroundings of the work machine 100 collected by the microphone A1.

The state identification part 302 of the machine controller 30 identifies, for example, the state of the work machine 100 based on the signals and information acquired by the acquisition part 301. Specifically, the state identification part 302 identifies, for example, the state of the work machine 100 including the posture of the attachment, the tilt angle of the upper turning body 3, the turning angular velocity of the upper turning body 3, the position and orientation of the upper turning body 3, and obstacles around the upper turning body 3.

The state identification part 302 of the machine controller 30 may process images of the imaging device S6 including, for example, the front camera S6F, the left camera S6L, the right camera S6R, and the rear camera S6B to generate a surrounding image (vicinity image) that is an image of the surroundings of the upper turning body 3. The surrounding image includes, for example, an image of the entire circumference of the upper turning body 3, that is, an image of the circumference of 360 degrees of the upper turning body 3. The surrounding image includes, for example, a bird's-eye view image of the work machine 100 viewed from above the work machine 100 and the surrounding objects. The bird's-eye view image includes, for example, a work machine icon illustrating the work machine 100 in the center. Further, the bird's-eye view image may be superimposed with a circular area illustrating the area through which the attachment passes when the upper turning body 3 turns, a person detection icon indicating a person existing around the upper turning body 3, and the like.

The transmission control part 303 of the machine controller 30 controls, for example, the communication device T1, and transmits the information and signal acquired by the acquisition part 301 and the information identified by the state identification part 302, to the remote communication device T2 of the remote operation room RC via the communication network NW. The transmission control part 303 may compress, for example, the signal and information transmitted via the communication device T1.

The reception control part 401 of the remote controller 40 controls, for example, the remote communication device T2, and receives the signal and information transmitted from the communication device T1 of the work machine 100 via the communication network NW. The reception control part 401 may decompress, for example, the received signal and information if they are compressed.

The display screen generation part 402 of the remote controller 40, for example, generates an image to be displayed on the display device D1 based on image information captured by the imaging device S6, transmitted via the communication device T1, and received by the reception control part 401 via the remote communication device T2.

The image generated by the display screen generation part 402 includes, for example, an image of the area in front of the upper turning body 3 captured by the front camera S6F, an image of the area to the left of the upper turning body 3 captured by the left camera S6L, an image of the area to the right of the upper turning body 3 captured by the right camera S6R, and an image of the area behind the upper turning body 3 captured by the rear camera S6B. If the machine controller 30 does not generate a surrounding image of the work machine 100, the display screen generation part 402 may generate a surrounding image of the work machine 100 based on image information of the imaging device S6 received via the reception control part 401, for example.

The determination part 403 of the remote controller 40 determines, for example, whether or not an image suitable for remote operation of the work machine 100 is displayed on the display device D1. Details of the processing by the determination part 403 will be described later.

The signal generation part 404 of the remote controller 40 generates an operation signal for controlling the operation of the work machine 100 in accordance with the operation contents of the remote operation device 42 by the remote operator OP detected by the operation sensor 43, for example. Further, the signal generation part 404 generates a signal for limiting the operation of the work machine 100 when, for example, the determination part 403 determines that an image suitable for the remote operation of the work machine 100 is not displayed on the display device D1.

The transmission control part 405 of the remote controller 40 controls, for example, the remote communication device T2, and transmits the signal generated by the signal generation part 404 to the communication device T1 of the work machine 100 via the remote communication device T2 and the communication network NW. Further, the transmission control part 405 may limit the signal to be transmitted to the communication device T1 of the work machine 100 when, for example, the determination part 403 determines that an image suitable for the remote operation of the work machine 100 is not displayed on the display device D1.

The reception control part 304 of the machine controller 30 controls, for example, the communication device T1 of the work machine 100, and receives, via the communication network NW and the communication device T1, information and signals transmitted from the remote communication device T2 of the remote operation room RC. The reception control part 304 receives, via the communication device T1, for example, an operation signal transmitted from the remote controller 40 of the remote operation room RC and a signal limiting the operation of the work machine 100.

The actuator drive part 305 of the machine controller 30 drives, for example, the actuator of the work machine 100 to operate the work machine 100. The actuator drive part 305 controls, for example, the regulator 13 and the valve 31 illustrated in FIG. 3 based on an operation signal based on the operation of the remote operator OP transmitted from the communication device T1 of the remote operation room RC and acquired by the acquisition part 301.

With this configuration, the remote operation system SYS of the work machine can display, on the display device D1 of the remote operation room RC, the image generated based on the image captured by the imaging device S6 provided in the work machine 100. The remote operator OP of the remote operation room RC can operate the remote operation device 42 while checking the surroundings of the work machine 100 by the image displayed on the display device D1.

The work machine 100 can operate the actuator by receiving an operation signal based on the operation of the remote operation device 42 by the remote operator OP via the communication device T1. Thus, the attachment of the work machine 100 can be operated by the remote operation of the remote operator OP of the remote operation room RC, and the upper turning body 3 can be turned, and the work machine 100 can be caused to travel.

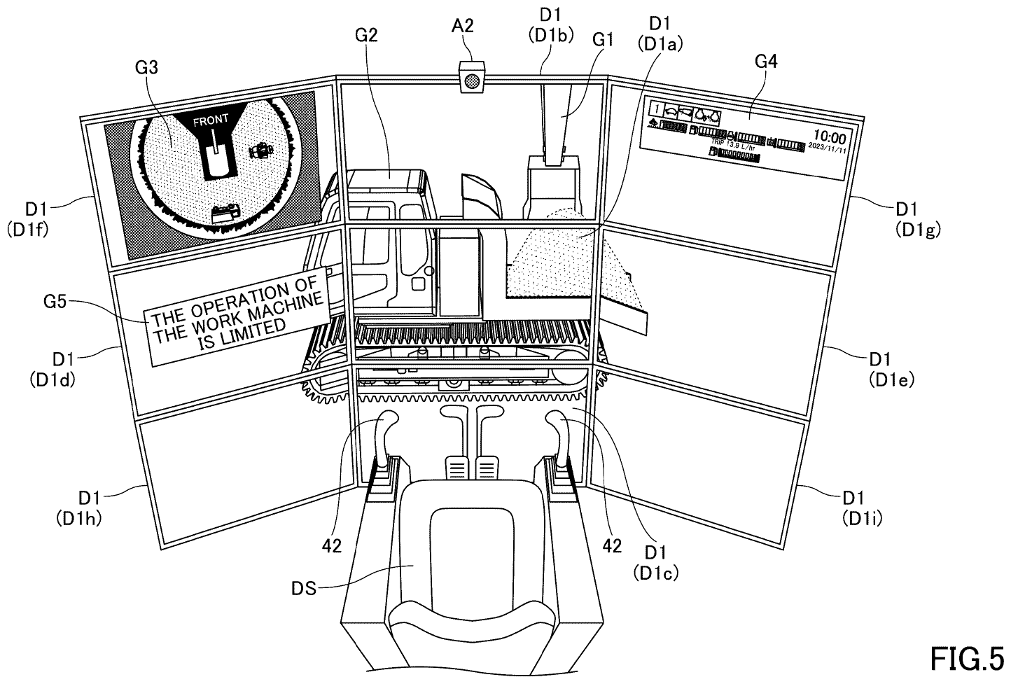

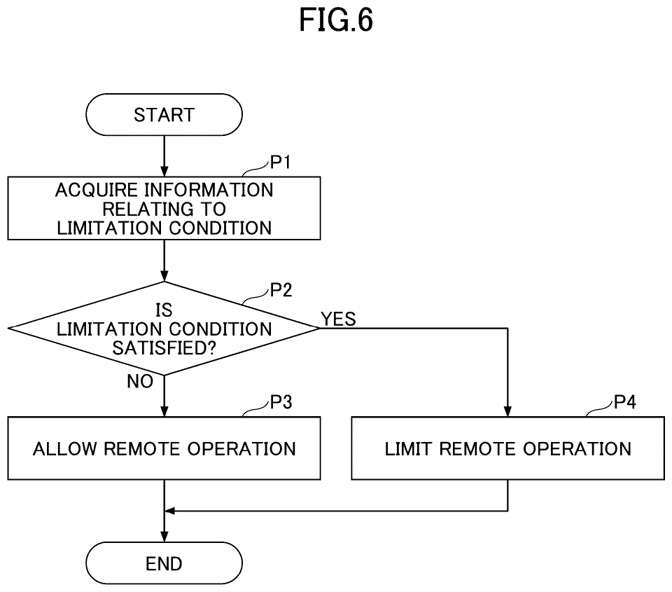

Next, the operation of the determination part 403 of the remote controller 40 will be described in detail with reference to FIGS. 5 and 6. FIG. 5 is a perspective view illustrating an example of the configuration of the display device D1 of the remote operation system SYS illustrated in FIG. 1. FIG. 6 is a flow diagram illustrating the processing flow of the remote operation system SYS illustrated in FIG. 1.

As described above, the remote operation system SYS of the work machine according to the present embodiment limits the remote operation of the work machine 100 when the limitation condition is satisfied such that an image suitable for the remote operation of the work machine 100 is not displayed on the display device D1. This limitation condition concerning the safety during the remote operation of the work machine 100 can be rephrased as a safety limitation condition during the remote operation of the work machine 100.

As illustrated in FIG. 5, for example, the display device D1 is a multi-display consisting of nine monitors having three vertical rows and three horizontal rows. Specifically, the display device D1 includes a center monitor D1a, an upper monitor D1b, a lower monitor D1c, a left monitor D1d, a right monitor D1e, an upper left monitor D1f, an upper right monitor D1g, a lower left monitor D1h, and a lower right monitor D1i.

The display device D1 displays, for example, a camera image which is an image captured by the imaging device S6 transmitted through the communication device T1 of the work machine 100 and received by the remote communication device T2 of the remote operation room RC. Specifically, the display device D1 displays at least one camera image selected by the remote operator OP among, for example, a front image captured by the front camera S6F, the left image captured by the left camera S6L, the right image captured by the right camera S6R, or the rear image captured by the rear camera S6B.

That is, the display device D1 may simultaneously display two or more images out of, for example, a front image, a left image, a right image, and a rear image, or may simultaneously display all images. When displaying a plurality of images simultaneously, for example, the display device D1 displays the plurality of images in a manner that does not obstruct the front view. Specifically, the display device D1 always displays the front image captured by the front camera S6F on, for example, the center monitor D1a and the upper monitor D1b.

In the example illustrated in FIG. 5, the display device D1 displays the front image captured by the front camera S6F. The front image includes, for example, an image G1 of an attachment of the work machine 100 and an image G2 of another work machine such as a transport machine cooperating with the work machine 100. Further, the display device D1 may display, for example, the front image in the center, and display the left image, the right image, and the rear image in the surrounding parts according to a selection by the remote operator OP.

In the example illustrated in FIG. 5, the display device D1 displays, for example, a surrounding image G3 which is an image of the surroundings of the work machine 100, superimposed on the camera image captured by the imaging device S6. The display device D1 also displays, for example, a state display image G4 which displays the state of the work machine 100 such as the measurement result of the measuring instruments of the work machine 100, superimposed on the camera image. Further, the display device D1 may display, for example, a notification image G5 including a message or a warning to the remote operator OP of the work machine 100 by superimposing the notification image G5 on the camera image.

Further, the display device D1 may display, for example, a menu image selectable by the remote operator OP by superimposing the display device D1 on the camera image. Further, the display device D1 may simultaneously display, for example, the surrounding image G3 and all the camera images described above. The image displayed on the display device D1 is generated, for example, by the display screen generation part 402 of the remote controller 40, which has received image information based on the image captured by the imaging device S6 of the work machine 100, as described above.

Next, a description will be given of a process in which the remote operation system SYS of the present embodiment limits the remote operation of the work machine 100 when the limitation condition is satisfied. When the process flow illustrated in FIG. 6 is started, for example, the remote operation system SYS of the work machine executes, first, a process P1 for acquiring information related to the limitation condition. The limitation condition indicates that an image suitable for the remote operation of the work machine 100 is not displayed on the display device D1.

Specifically, the limitation condition includes, for example, that an image of the area around the work machine 100 is not properly displayed on the display device D1. The image of the area around the work machine 100 includes, for example, the surrounding image G3 described above. The state in which the surrounding image of the work machine 100 is not properly displayed on the display device D1 includes, for example, the case in which the surrounding image G3 is not displayed on the display device D1, the case in which other images such as the state display image G4, the notification image G5, and the menu image are displayed by being superimposed on the surrounding image G3, or the case in which the surrounding image G3 is defective.

Therefore, the determination part 403 of the remote controller 40 acquires, for example, the display state of an image illustrating the state around the work machine 100 on the display device D1 in the process P1. Specifically, the determination part 403 acquires, for example, the display state of the surrounding image G3 on the display device D1 based on a signal input from the display screen generation part 402 to the display device D1. Further, the determination part 403 may acquire, for example, the display state of the surrounding image G3 based on an image captured by a camera installed in the remote operation room RC and capturing the display device D1.

The limitation condition includes, for example, that at least one state among the state of the imaging device S6, the communication state between the communication device T1 and the remote communication device T2, the image information input to the display device D1, or the state of the display device D1 does not satisfy a predetermined condition.

Therefore, the determination part 403 of the remote controller 40 acquires, for example, the state of the imaging device S6 in the process P1. Specifically, the machine controller 30 identifies, for example, the state of the imaging device S6 by the state identification part 302 in the process P1, and transmits the state of the imaging device S6 to the remote communication device T2 of the remote operation room RC via the communication device T1 by the transmission control part 303. The remote controller 40 receives the state of the imaging device S6 by the reception control part 401 via the remote communication device T2, and acquires the state of the imaging device S6 by the determination part 403.

Specifically, the state identification part 302 of the machine controller 30 identifies information related to the state of the imaging device S6, such as whether the imaging device S6 has a fault or disconnection, whether the installation state is abnormal, and whether the external environment is abnormal. More specifically, the state identification part 302 identifies, for example, whether the imaging device S6 has a fault or disconnection, and whether the external environment is abnormal, based on an image signal output from the imaging device S6. The abnormality caused by the external environment includes, for example, an abnormality of an image caused by raindrops or dust adhered to the lens of the imaging device S6, an abnormality of an image caused by weather such as snowfall or heavy rain, an abnormality of an image caused by insufficient light at night, and an abnormality of an image caused by sunlight or shadows.

The state identification part 302 of the machine controller 30 identifies, for example, an abnormality of the installation state of the imaging device S6, based on an image captured by the imaging device S6. More specifically, for example, an image including an image of a part of the work machine 100 captured by the imaging device S6 when the installation state of the imaging device S6 is normal, is stored in the nonvolatile storage device included in the machine controller 30. The state identification part 302 identifies the difference between the image of a part of the work machine 100 included in the image stored in the nonvolatile storage device and the image of a part of the work machine 100 included in the image newly captured by the imaging device S6. Then, if the difference between the images is within a predetermined range, the state identification part 302 identifies that the installation state of the imaging device S6 is normal, and if the difference between the images is outside the predetermined range, the state identification part 302 identifies that the installation state of the imaging device S6 is abnormal.

As the image of a part of the work machine 100 used for identifying the installation state of the imaging device S6, in the case of the front camera S6F, for example, an image of an attachment attached to the upper turning body 3 can be used. In this case, the posture of the attachment detected by the boom angle sensor S1, the arm angle sensor S2, the bucket angle sensor S3, and the like is associated with the image of the attachment and stored in the nonvolatile storage device. Then, a comparison is made with an image of the attachment captured in the same posture to identify the installation state of the front camera S6F. In the case of the left camera S6L, the right camera S6R, and the rear camera S6B, for example, an image of a part of the upper turning body 3 or a part of the counterweight mounted on the rear part of the upper turning body 3 can be used.

Note that the state of the imaging device S6 identified by the state identification part 302 of the machine controller 30 can also be identified by the determination part 403 of the remote controller 40. In this case, the determination part 403 of the remote controller 40 identifies the state of the imaging device S6 based on the image signal of the imaging device S6 received by the reception control part 401 of the remote controller 40 via the remote communication device T2, similar to the case of the state identification part 302 of the machine controller 30.

The determination part 403 of the remote controller 40 acquires, for example, the communication state between the communication device T1 and the remote communication device T2 in the process P1. Specifically, the determination part 403 acquires, from the communication device T1, for example, the numerical value of the bandwidth or the communication speed (bit rate) in the communication between the communication device T1 and the remote communication device T2. This is because a decrease in the communication bandwidth or the communication speed may cause block noise or the like in the transmitted image.

The determination part 403 of the remote controller 40 acquires, for example, the image information input to the display device D1 in the process P1. Specifically, the determination part 403 acquires, from the display screen generation part 402, for example, the image information generated by the display screen generation part 402 for displaying the image on the display device D1. This is because a failure may occur in the image information input to the display device D1.

The determination part 403 of the remote controller 40 acquires, for example, the state of the display device D1 from the display device D1 in the process P1. The state of the display device D1 includes, for example, the state of on/off of the power supply of the display device D1, whether or not the display device D1 is faulty, whether or not the wiring connected to the display device D1 is disconnected, and the like.

Next, the remote operation system SYS of the work machine executes a process P2 for determining whether or not the limitation condition is satisfied. In this process P2, the determination part 403 of the remote controller 40 determines whether or not the limitation condition is satisfied based on the information on the limitation condition acquired in the previous process P1.

In this process P2, if the determination part 403 determines that the limitation condition is not satisfied (NO), that is, if an image suitable for the remote operation of the work machine 100 is displayed on the display device D1, the remote controller 40 permits, for example, the remote operation of the work machine 100 (process P3). Thereafter, the remote operation system SYS ends the process flow illustrated in FIG. 6. In this case, the remote operator OP can perform the remote operation of the work machine 100 by operating the remote operation device 42 while viewing the image suitable for the remote operation displayed on the display device D1.

On the other hand, if the determination part 403 determines that the limitation condition is satisfied (YES) in this process P2, that is, if an image suitable for the remote operation of the work machine 100 is not displayed on the display device D1, the remote controller 40 limits, for example, the remote operation of the work machine 100 (process P4). Specifically, the remote controller 40 limits the remote operation of the work machine 100 when, for example, the determination part 403 determines that any of the following limitation conditions is satisfied.

That is, the limitation condition includes, for example, at least one of the following conditions. First, the surrounding image G3 is not properly displayed on the display device D1. Further, a fault or a disconnection has occurred in the imaging device S6. Further, an abnormality has occurred in the imaging device S6 due to the external environment. Further, the installation state of the imaging device S6 is abnormal. Further, the bandwidth or communication speed of communication between the communication device T1 and the remote communication device T2 is less than or equal to a predetermined threshold. Further, the image information to be input to the display device D1 is image information for displaying a monochromatic color to a predetermined number of pixels or more in the display device D1. Further, the power of the display device D1 is turned off. Further, a fault has occurred in the display device D1. Further, disconnection has occurred in the wiring connected to the display device D1.

In the process P4 for limiting the remote operation of the work machine 100, the remote operation system SYS of the work machine limits the remote operation of the work machine 100 by, for example, blocking or limiting a signal between the remote operation device 42 and the drive system for operating the work machine 100. Limiting the remote operation of the work machine 100 includes, for example, completely stopping the operation of the work machine 100, selectively stopping a specific operation of the work machine 100, or limiting the operation speed of the work machine 100 to a predetermined speed or less.

Specifically, the signal generation part 404 of the remote controller 40, for example, blocks the detection result of the operation of the remote operation device 42 obtained by the operation sensor 43 without acquiring the detection result, or blocks or limits the generation of an operation signal corresponding to the operation of the remote operation device 42. The transmission control part 405 of the remote controller 40, for example, blocks or limits the transmission of the operation signal generated by the signal generation part 404 according to the detection result obtained by the operation sensor 43.

Further, the remote controller 40 may generate a limitation signal limiting the operation of the work machine 100 by the signal generation part 404, for example, and transmit the limitation signal to the communication device T1 of the work machine 100 via the remote communication device T2 by the transmission control part 405. In this case, when the limitation signal is received via the communication device T1 by the acquisition part 301, for example, the machine controller 30 blocks or limits the operation signals output to the regulator 13, the valve 31, etc., by the actuator drive part 305.

When the limitation signal is received, the machine controller 30 limits the operation of the work machine 100 by the operation limitation part 306, for example. Specifically, the operation limitation part 306 switches the work machine 100 from the operable state to the inoperable state by electrically switching the communication state of the pilot line to the non-communication state, for example, in the same manner as when the gate lock lever is switched from the operable state to the inoperable state. The operation limitation part 306 may also switch the work machine 100 from the operable state to the inoperable state by stopping the engine 11, for example.

As described above, in the process P4, the remote operation system SYS limits the remote operation of the work machine 100 by at least one of, for example, limiting the operation of the work machine 100, limiting the output signal of the remote operation device 42, or limiting the communication between the remote communication device T2 and the communication device T1.

Further, in the process P4, the remote operation system SYS generates a notification image G5 notifying the remote operator OP that the remote operation of the work machine 100 is limited by the display screen generation part 402 of the remote controller 40, for example, and displays the notification image G5 on the display device D1. The display screen generation part 402 may also generate a notification image G5 notifying the information about the limitation condition determined to be satisfied in the process P2, such as a decrease in the communication bandwidth, and display the notification image G5 on the display device D1. Further, the remote operation system SYS may, for example, generate a voice signal for notifying the fact that the remote operation of the work machine 100 has been limited by the signal generation part 404, the limitation conditions at that time, etc., and output the notification voice from the speaker A2.

Thereafter, the remote operation system SYS ends the processing flow illustrated in FIG. 6 and repeatedly executes the processing flow at a predetermined cycle.

If the state in which the image suitable for the remote operation of the work machine 100 is not displayed on the display device D1 continues, the determination part 403 of the remote controller 40 repeatedly determines that the limitation condition is satisfied (YES) in process P2 in the second time around and beyond, and the limitation of the remote operation continues in the process P4. Therefore, if the limitation condition in which the image suitable for the remote operation of the work machine 100 is not displayed on the display device D1 is satisfied, the transition from the disabled state to the enabled state of the operation lever of the remote operation device 42 is limited. That is, limiting the remote operation of the work machine 100 when the limitation condition is satisfied includes limiting the transition from the disabled state to the enabled state of the operation lever of the remote operation device 42.

On the other hand, the remote operation system SYS may execute a return process of returning to the remote operation of the work machine 100 when the determination part 403 of the remote controller 40 determines that the limitation condition is not satisfied (NO) in the process P2 because, for example, the bandwidth of the communication between the communication device T1 and the remote communication device T2 increases.

In the return process of returning to the remote operation, for example, the remote operation system SYS generates a notification image G5 notifying that the remote operation of the work machine 100 is enabled by the display screen generation part 402 of the remote controller 40, and displays the notification image G5 on the display device D1. Further, the display screen generation part 402 generates a menu image for selecting, for example, whether or not to permit the resumption of the remote operation of the work machine 100, and displays the menu image on the display device D1. The remote operator OP operates, for example, the remote operation device 42 to select whether or not to permit the resumption of the remote operation of the work machine 100.

When the remote operator OP permits the resumption of the remote operation, the remote controller 40, for example, releases the limitation of the remote operation executed in the process P4, and notifies, via the remote communication device T2, the communication device T1 of the work machine 100, of the release of the limitation of the remote operation. When the machine controller 30 receives the notification of the release of the limitation of the remote operation via the communication device T1, the machine controller 30 releases the limitation of the remote operation executed in the process P4. When the remote operator OP does not permit the resumption of the remote operation, the remote operation system SYS ends the remote operation of the work machine 100.

As described above, the remote operation system SYS of the work machine of the present embodiment includes the work machine 100, the remote communication device T2, the display device D1, and the remote operation device 42. The work machine 100 includes a lower traveling body 1, an upper turning body 3 provided on the lower traveling body 1 so as to be able to turn, an imaging device S6 provided on the upper turning body 3, and a communication device T1 for transmitting an image captured by the imaging device S6. The remote communication device T2 communicates with the communication device T1 of the work machine 100. The display device D1 is configured to display the image received by the remote communication device T2. The remote operation device 42 is configured to operate the work machine 100. Thereby, the remote operation system SYS of the present embodiment limits the remote operation of the work machine 100 when the limitation condition is satisfied such that an image suitable for the remote operation of the work machine 100 is not displayed on the display device D1.

With this configuration, the remote operation of the work machine 100 by the remote operator OP is limited when the limitation condition is satisfied in the state that an image suitable for the remote operation of the work machine 100 is not displayed on the display device D1. Thus, the remote operation of the work machine 100 by the remote operator OP is prevented in the state that the remote operator OP cannot confirm the image suitable for the remote operation displayed on the display device D1, and the safety of the remote operation of the work machine 100 is improved. Further, when the image suitable for the remote operation of the work machine 100 is displayed on the display device D1, the limitation condition is not satisfied. Therefore, the remote operator OP can operate the remote operation device 42 while confirming the display device D1 on which the image suitable for the remote operation of the work machine 100 is displayed, and the remote operation of the work machine 100 can be smoothly performed.

In the remote operation system SYS of the work machine of the present embodiment, the limitation condition includes that the image of the area around the work machine 100 is not properly displayed on the display device D1.

With such a configuration, the remote operator OP can remotely operate the work machine 100 by operating the remote operation device 42 while confirming the display device D1 in which the image of the area around the work machine 100 is properly displayed, for example, as illustrated in the surrounding image G3 illustrated in FIG. 5. Thus, the remote operator OP can remotely operate the work machine 100 so as to avoid objects around the work machine 100, and the safety of the remote operation of the work machine 100 can be further improved.

In the remote operation system SYS of the work machine of the present embodiment, the limitation condition includes that at least one of the state of the imaging device S6, the communication state between the communication device T1 and the remote communication device T2, the image information input to the display device D1, or the state of the display device D1 does not satisfy the predetermined condition.

With such a configuration, the remote operation of the work machine 100 can be limited when an image suitable for the remote operation is not displayed on the display device D1 due to the physical state of the imaging device S6, the communication state, a failure during image processing, the physical state of the display device D1, etc. Therefore, according to the remote operation system SYS of the work machine of the present embodiment, the safety of the remote operation of the work machine 100 can be improved.

Further, in the remote operation system SYS of the work machine of the present embodiment, the limitation of remote operation includes the blocking or limitation of signals between the remote operation device 42 and the drive system for operating the work machine 100.

With such a configuration, the operation of the work machine 100 can be limited even when the remote operator OP operates the remote operation device 42 in a state where the limitation condition that an image suitable for remote operation is not displayed on the display device D1 is satisfied. Therefore, according to the remote operation system SYS of the work machine of the present embodiment, the safety of remote operation of the work machine 100 can be improved.

In the remote operation system SYS of the work machine of the present embodiment, the limitation of remote operation includes at least one of the limitation of operation of the work machine 100, the limitation of output signals of the remote operation device 42, or the limitation of communication between the remote communication device T2 and the communication device T1.

With such a configuration, when the limitation condition is satisfied, the remote operation of the work machine 100 can be surely limited by the limitation of operation of the work machine 100, the limitation of output signals of the remote operation device 42, or the limitation of communication between the remote communication device T2 and the communication device T1. Therefore, according to the remote operation system SYS of the work machine of the present embodiment, the safety of remote operation of the work machine 100 can be improved.

The remote operation system SYS of the work machine of the present embodiment further includes the machine controller 30 connected to the communication device T1 to control the lower traveling body 1 and the upper turning body 3, and the remote controller 40 connected to the remote communication device T2 and the remote operation device 42 to control the display device D1. The machine controller 30 or the remote controller 40 limits the remote operation of the work machine 100 when the limitation condition is satisfied.

With this configuration, the operation of the work machine 100 can be limited by the machine controller 30. Further, the remote controller 40 can limit the output signal of the remote operation device 42 and the communication between the remote communication device T2 and the communication device T1. Therefore, the remote operation system SYS of the work machine of the present embodiment can improve the safety of the remote operation of the work machine 100.

As described above, according to the present embodiment, the remote operation system SYS of the work machine can be provided, which enables the remote operation of the work machine 100 in a state where an image suitable for the remote operation of the work machine 100 is displayed on the display device D1.

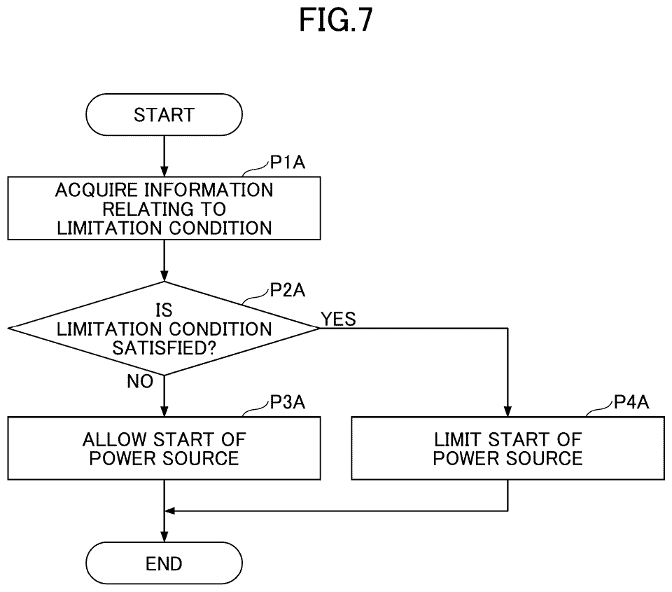

Next, a modified example of the above-described embodiment will be described with reference to FIG. 7. FIG. 7 is a flow diagram illustrating a modified example of the processing flow in the remote operation system SYS illustrated in FIG. 6. Each of the processes illustrated in the flow diagram of FIG. 6 described in the above-described embodiment is executed after the start of the power source of the work machine 100, while each of the processes illustrated in the flow diagram of FIG. 7 is executed before the start of the power source of the work machine 100, which is different from the above-described embodiment.

When the remote operation system SYS of the work machine starts the processing flow illustrated in FIG. 7 before the start of the power source of the work machine 100, the remote operation system SYS executes the process P1A for acquiring information on the limitation condition, similar to the process P1 illustrated in FIG. 6. Next, the remote operation system SYS executes the process P2A for determining whether the limitation condition is satisfied or not, similar to the process P2 illustrated in FIG. 6.

In the process P2A, if the determination part 403 determines that the limitation condition is not satisfied (NO), that is, if an image suitable for the remote operation of the work machine 100 is displayed on the display device D1 as in the above-described embodiment, the remote controller 40 permits, for example, the start of the power source of the work machine 100 (process P3A). After that, the remote operation system SYS ends the processing flow illustrated in FIG. 7.

On the other hand, in the process P2A, if the determination part 403 determines that the limitation condition is satisfied (YES), that is, if an image suitable for the remote operation of the work machine 100 is not displayed on the display device D1 as in the above-described embodiment, the remote controller 40 limits, for example, the start of the power source of the work machine 100 (process P4A). The power source of the work machine 100 is, for example, the engine 11 or a combination of a power supply and an electric motor as described above.

As a result, the remote operation of the work machine 100 by the remote operation device 42 is limited. That is, limiting the remote operation of the work machine 100 when the limitation condition that an image suitable for remote operation is not displayed on the display device D1 is satisfied includes limiting the start of the power source of the work machine 100. In this modified example, as in the above-described embodiment, the remote operation system SYS for the work machine that enables the remote operation of the work machine 100 in the state that an image suitable for remote operation of the work machine 100 is displayed on the display device D1, can be provided.

Thus, an embodiment of the present disclosure has been explained. However, the invention of the present disclosure is not limited to the above-described embodiment. The above-described embodiment can be applied with various modifications, substitutions, etc., without departing from the scope of the invention of the present disclosure. Further, each of the features described with reference to the above-described embodiment may be appropriately combined as long as there is no technical contradiction.

What is claimed is:

1. A remote operation system for a work machine, the remote operation system comprising:
the work machine including:
a lower traveling body;
an upper turning body provided on the lower traveling body so as to be able to turn;
an imaging device provided on the upper turning body; and
a communication device configured to transmit an image captured by the imaging device;
a remote communication device configured to communicate with the communication device;
a display device configured to display the image received by the remote communication device; and
a remote operation device configured to operate the work machine by performing a remote operation, wherein
the remote operation system limits the remote operation when a limitation condition is satisfied, the limitation condition being that an image suitable for the remote operation of the work machine is not displayed on the display device.

2. The remote operation system according to claim 1, wherein the limitation condition includes that an image of an area surrounding the work machine is not properly displayed on the display device.

3. The remote operation system according to claim 1, wherein the limitation condition includes that at least one of a state of the imaging device, a state of communication between the communication device and the remote communication device, image information input to the display device, or a state of the display device, does not satisfy a predetermined condition.

4. The remote operation system according to claim 1, wherein the limiting of the remote operation includes blocking or limiting a signal between the remote operation device and a drive system for operating the work machine.

5. The remote operation system according to claim 1, wherein the limiting of the remote operation includes at least one of limiting an operation of the work machine, limiting an output signal of the remote operation device, or limiting communication between the remote communication device and the communication device.

6. The remote operation system according to claim 1, further comprising:
a machine controller connected to the communication device to control the lower traveling body and the upper turning body; and
a remote controller connected to the remote communication device and the remote operation device to control the display device, wherein
the machine controller or the remote controller limits the remote operation when the limitation condition is satisfied.
